(19) United States
(12) Patent Application Publication
(10) Pub. No.: US 2010/0100568 A1
(43) Pub. Date: Apr. 22, 2010

(54) METHOD FOR AUTOMATIC PREDICTION OF WORDS IN A TEXT INPUT ASSOCIATED WITH A MULTIMEDIA MESSAGE

(76) Inventors: Christophe E. Papin, Bois Colombes (FR); Jean-Marie Vau, Paris (FR)

Correspondence Address: EASTMAN KODAK COMPANY;PATENT LEGAL STAFF, 343 STATE STREET, ROCHESTER, NY, 14650-2201, US

(21) Appl. No.: 12/519,764

(22) PCT Filed: Dec. 3, 2007
(86) PCT No.: PCT/EP2007/010467

§ 371 Date: Jun. 18, 2009

(30) Foreign Application Priority Data
Dec. 19, 2006 (FR) 06/11032

(51) Int. Cl. G06F 17/30

(52) U.S. Cl. 707/794; 707/E17.102

(57) ABSTRACT

The invention is in the technological field of digital imaging. More specifically, the invention relates to a method for automatic prediction of words when entering the words of a text associated with an image (6). The object of the invention is a method whereby a terminal (1) connected to a keypad (2) and a display (3) is used for selecting an image (6) and providing automatic assistance by proposing words when inputting text associated with the content or context of the selected image. The invention method is mainly intended to be used to make it quicker and easier to input text associated with an image using a mobile electronic device, such as for example a mobile cellphone or phonecam.

### FIELD OF THE INVENTION

The invention is in the technological field of digital imaging. More specifically, the invention relates to a method for automatic prediction of words when entering the words of a text associated with an image or a sequence of images. The object of the invention is a method whereby a terminal connected to a keypad and a display is used for selecting an image or sequence of images and providing automatic assistance by proposing words when inputting text associated with the content or context of the selected image.

### BACKGROUND OF THE INVENTION

Inputting text using small keypads with a limited number of keys, i.e. the keypads integrated into mobile terminals such as mobile phones or phonecams, remains a somewhat tedious task, and can quickly become tiring if the text message is long. This is the case with a standard 12-key ITU-T E.161 keypad, which has only 8 keys to cover the whole alphabet. There are several ways of using these keypads to input text. The simplest method, as used by the older generation phones, is called ‘multi-tap’ or ‘ABC’ and involves pressing the key with the required letter on it ‘n’ amount of times, where ‘n’ is the letter's position in the letter group printed on the key. For example, to obtain the letter ‘s’, it would be necessary to press four times on the key assigned the p, q, r, s group.

Another method, called the ‘two-key’ system, limits the selection of any letter by pressing on only two keys.

However, the most widely-used text input technique is predictive text input, which eradicates the ambiguity caused by the huge number of possible letter combinations or associations matching the same input sequence by implementing a dictionary database. The dictionary can, for example, be stored in the telephone's internal memory. This dictionary contains a selection of the most commonly used words in the target language. The T9® protocol developed by Tegic Communications is a predictive text technology widely used on mobile phones from brands including LG, Samsung, Nokia, Siemens and Sony Ericsson. The T9® protocol is a method that, using the standard ITU-T E.161 keypad, predicts by guess-work the words being inputted. It makes text messaging faster and simpler, since it cuts down the number of keypresses required. The T9® protocol deploys an algorithm that uses a fast-access dictionary containing the majority of commonly used words and offering the most frequently used words first, to make it possible to combine letter groups, each letter being assigned to one of the keys on the terminal's keypad, the goal being to recognize and propose a word while the text is being inputted via the terminal's keypad. The T9® protocol is predictive in that it enables a word to be typed by pressing on only on key per letter in the word.

The T9® protocol uses a dictionary (i.e. a word database) to find common words in response to keypress sequences. For example, in T9® mode, pressing on keypad keys ‘5’ and then ‘3’ will bring up options between ‘j’, ‘k’ and ‘l’ for the first letter and ‘d’, ‘e’ and ‘f’ for the second letter. T9® will then find the two combinations of the commonly used words ‘of’ or ‘me’ if it is being used in the English language version. By pressing, for example, on the ‘0’ key on the terminal's keypad, it becomes possible to switch between these two word options and choose the appropriate word for the text being typed. The user may want to use the word ‘kd’ for example, which is probably not a real word. The user must then go into a mode called ‘multikey’ and the word will automatically be added to the dictionary. If, for example, the user wants to type the word ‘worker’, they have to proceed as follows: since ‘w’ is on key ‘9’, press once on key ‘9’; the screen shows the letter ‘y’ appears, but that is not a problem, you just keep typing; since ‘o’ is on key ‘6’, press once on key ‘6’; the screen shows the letters ‘yo’, but that is not a problem, you just keep typing until the ‘r’ at the end of the word, at which point the word ‘worker’ is displayed. By pressing on key ‘0’ for example, it is possible to scroll though other available words, for example ‘yorker’, and select the appropriate word for the text being typed. There is no need to press several times on the same key or to wait for a letter in a word to be confirmed before moving on to the next letter, even when two adjacent letters are on the same key, which saves considerable time. The efficiency of this kind of protocol can be improved if the dictionary is adapted to the user by adding new words, which is done either directly by the user or via automated user pattern ‘learning’ procedures. It is also possible to extract new words, for example from the content of previously-typed messages or from emails received. There are a variety of similar predictive text methods, such as Motorola's ‘iTap’ or ZiCorp's ‘eZiText’. Eatoni Ergonomics have developed WordWise technology, which is also a predictive text input solution but one that works in an essentially different implementation of the method than the T9® protocol.

Other, similar methods are known, in the state of the art, for predicting words during text input, based on offering a series of words or phrases from the outset, before the user has had to type in all the letters in the word. Motorola's ‘iTap’ protocol is one example. ‘iTap’ is able to guess the words, phrases or even full sentences required by the user, before the user has typed out a number of letters equal to the full word length. iTap technology is built on a dictionary containing phrases and commonly used expressions designed to enable the best match based on the context of the word being typed. However, the iTap method is deemed more difficult for users to understand than the T9® method. Indeed, the list of words (i.e. not user-defined words) that are offered before the desired word appears in the list will tend to be longer than when using T9®, since the ‘iTap’ method will continue to search to add characters to the series of words thus far entered. The ‘iTap method’ makes it possible to predict words or even whole phrases without having to type all the letters in those words. Nevertheless, the methods implemented by iTap to predict words or phrases that the user may want to employ are different from the methods according to the present invention, as will become clear in the following description.

Mobile terminals such as mobile phonecams are able to send multimedia messages. Multimedia messages can advantageously contain image, video, text, animation or audio files (sound data). These messages can, for example, be transmitted over wireless communication networks. Text data can, for example, be notes associated with the content of a digital image. Data content can, for example, be transmitted from a mobile phone via a multimedia messaging service, or MMS, or else via electronic mail (e-mail). These communication means make it possible to instantaneously transmit the images together with the texts associated with these images, and then to share them with other people, for example between a mobile phonecam and a web log (or ‘blog’) on the Internet.

These new means of communication open up much wider possibilities than simply transferring multimedia content simply and rapidly. They make it possible to tell a story or share an experience, by commenting on or describing the content associated with or attached to a multimedia message. The phonecam is fairly well-suited to instantaneously editing comments on multimedia content (messages): for example, by adding text comments on an event related to a photo taken with the phonecam and transferring both photo and associated text to other, remote electronic platforms from which the multimedia content (message) can be accessed and enhanced with other text comment. In particular, the text can be used to tell a personal story about one or more of the people featuring in the photo, or to the express the feelings and emotions stirred by the scene in the photo, etc.

Users of mobile media platforms therefore often feel the need to exchange and share a whole lot more than a simple text message counting just a handful of words. Users of mobile media platforms also need to simultaneously share a wide panel of multimedia contents. The multimedia content includes in particular image data and the text data associated with the image; there may be a relatively large amount of text data, for example several dozen words. Users sharing this multimedia data need to be able to add their own comments or to respond to an event presented as a photo or a video, which means they need to write more and more text (not just a handful of words) relating to the content of the photo or the context it was taken in.

It consequently becomes necessary to make it easier to write relatively long texts using means that enhance the means known in the state of the art, for example the T9® protocol.

The ability to associate a text to be written with a multimedia content intended to be forwarded as a multimedia message or as an email, using a mobile terminal equipped with a means of wireless communication, offers an opportunity to advantageously improve on current predictive text imputing techniques by combining the use of semantic data extracted from the multimedia content with contextual data advantageously specifying the environment in which the photo was taken and the history of the photo.

### SUMMARY OF THE INVENTION

The object of the present invention is to facilitate how textual information specific to an image or a sequence of images, for example a video, is written, by making it easier to write text associated with the image or sequence of images, in particular when interactive messages are shared between mobile platforms, for example. These messages include both images and the textual information associated with these images.

The object of the invention is to facilitate how textual information associated with an image is written by automatically predicting and proposing, while the text describing the image is being written, words whose content is related to the image, i.e. words whose semantic meaning is adapted to the image content, or in an advantageous embodiment, to the context in which the image was captured. The objective is to facilitate how the text is written while at the same time reducing the time needed to write the text, especially when using a terminal fitted with a keypad having a low key number and (or) capacity.

The object of the invention is to propose a specific word-based dictionary that is a database containing words which have a semantic meaning that matches the content or the context of an image or a sequence of images.

More precisely, an object of the invention is a method, using a terminal connected to a keypad and a display, for automatically predicting at least one word saved in a database that can be accessed using the terminal, this at least one word characterizing an image content or a context associated with an image or a sequence of images, the at least one word having been predicted in order to complete a text-based message associated with the image content or the context of the image or sequence of images while inputting the message text using the terminal, said method comprising the following steps:
a) selection of the image or the sequence of images using the terminal;
b) based on at least one new letter entered into the text using the terminal, to predict and automatically propose at least one word beginning with the at least one new letter, this word being a word recorded in the database;
c) automatic insertion of the at least one predicted and proposed word into the text.

It is an object of the invention that the word proposed is produced based on a semantic analysis of the selected image or sequence of images using an algorithm that preferentially classifies the pixels or a statistical analysis of the pixel distributions or a spatiotemporal analysis of the pixel distributions over time or a recognition of the outlines produced by sets of connected pixels in the selected image or sequence of images.

It is also an object of the invention that the word proposed is produced based on a contextual analysis of the selected image or sequence of images using an algorithm that provides geolocation and (or) dating information specific to the image or sequence of images, such as for example the place where the image or sequence of images was captured.

It is also an object of the invention that the word proposed is produced based on a semantic analysis of the selected image or sequence of images and based on a contextual analysis of the selected image, i.e. based on a combination of a semantic analysis and a contextual analysis of the selected image or sequence of images.

It is another object of the invention that the word proposed is, in addition, produced based on a semantic analysis of audio data associated with the selected image or sequence of images.

Other characteristics and advantages of the invention will appear on reading the following description, with reference to the various figures.

### BRIEF DESCRIPTION OF THE DRAWINGS

FIG. 1 shows an example of the hardware means used to implement the method according to the invention.

FIG. 2 schematically illustrates a first mode of implementation of the method according to the invention.

FIG. 3 schematically illustrates a second mode of implementation of the method according to the invention.

### DETAILED DESCRIPTION OF THE INVENTION

The following description is a detailed description of the main embodiments of the invention with reference to the drawings in which the same number references identify the same elements in each of the different figures.

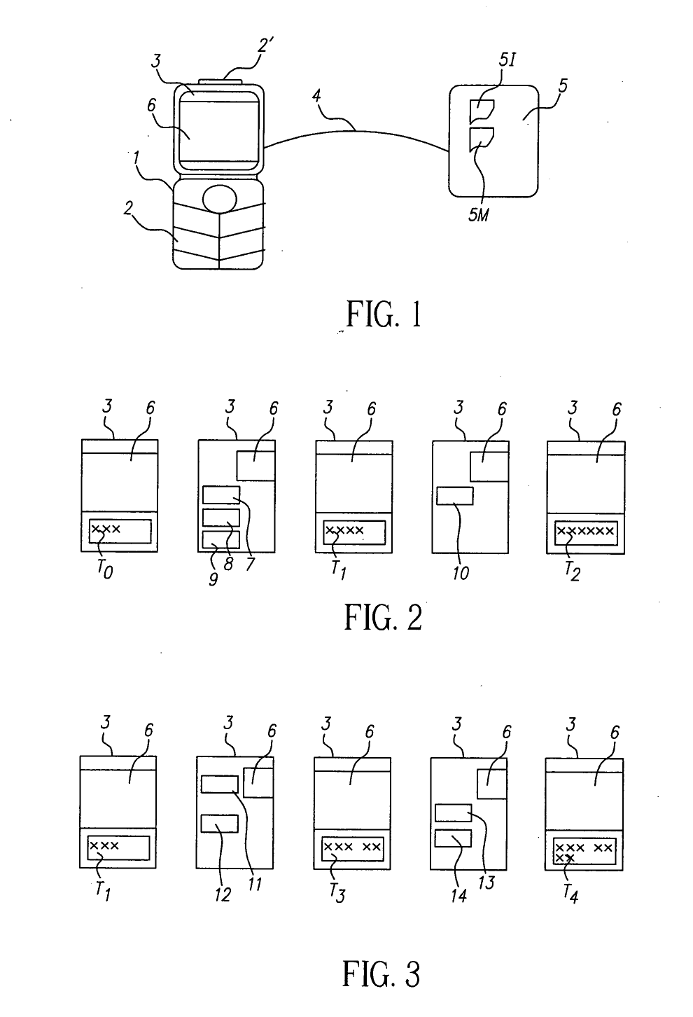

The invention describes a method for automatically predicting at least one word of text while a text-based message is being inputted using a terminal 1. According to FIG. 1, the terminal 1 is, for example, a mobile cell phone equipped with a keypad 2 and a display screen 3. In an advantageous embodiment, the mobile terminal 1 can be a camera-phone, called a ‘phonecam’, equipped with an imaging sensor 2′. The terminal 1 can communicate with other similar terminals (not illustrated in the figure) via a wireless communication link 4 in a network, for example a UMTS (Universal Mobile Telecommunication System) network. According to the embodiment illustrated in FIG. 1, the terminal 1 can communicate with a server 5 containing digital images that, for example, are stored in an image database 51. The server 5 may also contain a word database 5M. The server 5 may also serve as a gateway that provides terminal 1 with access to the Internet. In another embodiment, the images and words can be saved to the internal memory of terminal 1.

The majority of mobile terminals are equipped with means of receiving, sending or capturing visual image or video data. However, the method that is the object of the invention has the advantage that it can be implemented with even the simplest of cell phones, i.e. cell phones without means of image capture, as long as the cell phone can receive and send image or sequence of images (videos) data. The method that is the object of the invention is a more effective and more contextually-adapted means of inputting a text-based message associated with an image than the T9® method or even the ‘iTap’ method.

In the description that follows, the word image is used to indicate either a single image or a sequence of images, i.e. a short film or a video, for example. The image can, for example, be an attachment to a multimedia message. The multimedia message can contain image, text and audio data. The text-based data can, for example, be derived and extracted from image metadata, i.e. data that, for example, is specific to the context in which the image was captured and that is stored in the EXIF fields associated with JPEG images. The file format supporting the digital data characterizing the image, text or audio data is advantageously an MMS (Multimedia Message Service) format. The MMS can therefore be transferred between digital platforms, for example between mobile terminals or between a server such as server 5 and a terminal such as mobile terminal 1.

The image can also, for example, be attached to another means of communication such as a electronic mail (e-mail).

The invention method can be applied directly, as soon as an image or video 6 has been selected. The image is advantageously selected using terminal 1 and then displayed on the display 3 of terminal 1. Image 6 can, for example, be saved or stored in the image database 5I. Otherwise, image 6 may just have been captured by terminal 1, and it may be that the user of terminal 1 wants to instantaneously add textual comment related to the content of the image 6 or, for example, related to the context in which image 6 was captured.

The invention method consists in taking advantage of the information contained in the image in order to facilitate the prediction of at least one word of text related to the content or context associated with image 6. The at least one predicted word already exists and for example is contained in the word database 5M. The word database 5M is, compared to the dictionary used in the T9® protocol, advantageously a specially-designed dictionary able to adapt to the image content or the or context associated with the image. The dictionary is self-adapting because it is compiled from words derived from contextual and (or) semantic analysis specific to a given image. These words are then adapted to the text correlated with image 6.

The word dictionary 5M is built from the moment where at least one image or at least one sequence of images has been selected via a messaging interface, for example an MMS messaging interface, or by any other software able to associate a text message with an image or a sequence of images with the objective of sharing the text and the image or images. Once the text-based message (associated with the image) and the image have been sent, or else once the text-based message and the image have been saved to the mobile terminal's memory or to a remote memory that can be accessed via a means of communication compatible with the mobile terminal, then the dictionary 5M associated with that specific image or images(s) or specific sequence(s) of images is destroyed. Hence, the next time a new image or sequence of images is selected, a new dictionary 5M will be compiled based on the semantic and (or) contextual data derived from the new multimedia data.

In another embodiment of the method, the dictionary 5M associated with an image or a specific sequence of images is saved to memory, ready to be used at a later time.

In an alternative embodiment, the dictionary 5M may be built for each set of multimedia data before the user has sent a message. In this latter scenario, the user does not see the dictionary 5M being built. This involves saving a back-up of each dictionary 5M associated with each set of image or image sequence-based multimedia data. If several images or sequences of images are selected for the same multimedia message, this involves building a new dictionary 5M compiled from at least the words comprising the vocabulary of each of the various dictionaries 5M associated with each selected image or sequence of images.

The word database 5M can automatically offer the user a word or a series of words as the user is writing a text-based message associated with image 6 via the keypad 2. A series of several words will automatically be offered together from the outset, for example when the predictive text leads to an expression or a compound noun. The text-based message written can advantageously be displayed with the image 6 on display 3 of mobile terminal 1, and the predicted word proposed can also be displayed automatically on the display 3, for example as soon as the first letter of said word has been inputted using keypad 2. The word proposed is advantageously displayed in a viewing window of display 3 that is positioned, for example, alongside the image 6. The word can then be automatically inserted at the appropriate place in the text being written.

When at least one new letter of the text being inputted using the terminal leads to several possible proposals, i.e. all of which have a meaning in relation to the semantic of the text being written, given the content of the image or, for example, the context in which the image was captured, the word predicted and proposed that was chosen from among the proposals can be selected by pressing, for example by touch, on the display 3. The pressure is applied to the word that the person inputting the text with keypad 2 chooses as most closely matching what they want to say. In one variant of this embodiment, when several proposals have been predicted, the predicted and proposed word chosen can also be selected using one of the keys of the keypad 2 of terminal 1.

In an advantageous embodiment of the method according to the invention, the automatic prediction and proposal of at least one word is conducted in cooperation with the T9® protocol. This means that the words proposed can be derived from both the word database 5M (the specially-designed self-adapting dictionary) specific to the present invention and from another database (not illustrated in FIG. 1 specific to the T9® protocol. The words derived from each of these dictionaries (both the T9® dictionary and the dictionary according to the present invention) can therefore be advantageously combined.

The predicted and proposed word is produced based on a semantic analysis of the image or sequence of images selected using terminal 1. The semantic analysis can be conducted inside the image via an image analysis algorithm which classifies pixels, or via a statistical analysis of pixel distribution, or else via a spatiotemporal analysis of pixel distribution over time. The semantic analysis can be conducted based on recognition of the outlines produced by sets of connected pixels in the selected image or sequence of images. The outlines detected and recognized are, for example, faces.

The extraction of semantic information from within an image, i.e. information related to the characterization or meaning of an entity contained in the image, also makes it possible to build and enhance the content of the specially-designed self-adapting dictionary 5M. If the image 6 features, for example, a couple running across a sandy beach with a dog, then the image analysis algorithm will segment the content of image 6 into semantic layers. In this particular scenario, specially-designed sensors recognize and outline in image 6 zones of white sand and zones of seawater and blue sky, based on, for example, the methods described in U.S. Pat. No. 6,947,591 or U.S. Pat. No. 6,504,951 filed by Eastman Kodak Company. Classification rules are used to characterize the scene in the image as being, for example, a ‘beach’ scene, based on the fact that the scene contains both blue sea zones and white sand zones. These classification rules can, for example, be based on the methods described in U.S. Pat. No. 7,062,085 or U.S. Pat. No. 7,035,461 filed by Eastman Kodak Company. Other semantic classes can stem from an image analysis, such as, for example, ‘birthday’, ‘party’, ‘mountain’, ‘town’, ‘indoors’, ‘outdoors’, portrait', ‘landscape’, etc.

The combined use of a visual cue and a sound cue attached, for example, to a video enables a more comprehensive analysis of the content. In the same way, the use of audio data, for example spoken notes (lyrics) attached to an image can be advantageously used to deduce words characterizing the content of the image. An example of how the system works is detailed in U.S. Pat. No. 7,120,586 filed by Eastman Kodak Company. Some of these semantic descriptors, in addition to others, can also be deduced from the image capture mode selected that is widely known as ‘scene’. A Nokia N90 mobile phone, for example, can be used to define a ‘scene’ mode at the time of image capture as: ‘night’, ‘portrait’, ‘sport’, ‘landscape’. One of these words can advantageously be added to the dictionary 5M when the user has selected the respective mode. There are other widely-used ‘scene’ modes, particularly in Kodak digital cameras. The Kodak Easyshare C875 model, for example, proposes the following scene modes: ‘portrait’, ‘night portrait’, ‘landscape’, ‘night landscape’, ‘closeup’, ‘sport’, ‘snow’, ‘beach’, ‘text/document’, ‘backlight’, ‘manner/museum’, ‘fireworks’, ‘party’, ‘children’, ‘flower’, ‘self-portrait’, ‘sunset’, ‘candle’, ‘panning shot’. Here again, the wording used to describe each of these modes can be integrated into the dictionary 5M as soon as the user selects one of these modes. There is also a ‘scene’ mode known as automatic, which is designed to automatically find the appropriate ‘scene’ mode, for example according to the light and movement conditions identified by the lens. The result of this analysis may, for example, be the automatic detection of the ‘landscape’ mode. This word can then be incorporated into the dictionary 5M. Let us suppose that this is the case in the example scenario described above. The image analysis algorithm detects the specific pixel zones presenting the same colour and texture characteristics, which are generally learnt beforehand through so-called ‘supervised’ learning processes implementing image databases manually indexed as being, for example, sand, grass, blue sky, cloudy sky, skin, text, a car, a face, a logo etc., after which the scene in the image is characterized. If, as described in U.S. Pat. No. 6,940,545 or U.S. Pat. No. 6,690,822 filed by Eastman Kodak Company, a face is detected and recognized as being the face of ‘John’, and if another face is detected but cannot be recognized since it is side-on, or blurred, or hidden behind hair, a group of two people is nevertheless detected and the algorithm used in the invention method leads to the proposal of, for example, the following words: ‘John’, ‘friend’, ‘girlfriend’, ‘wife’, ‘husband’, ‘son’, ‘daughter’, ‘child’, or combinations of these words, for example ‘John and a friend’, ‘John and his wife’, ‘John and his son’, plus a ‘dog’. All this information can therefore be advantageously used to build up a dedicated dictionary with semantic words and expressions describing the visual content of an image or sequence of images attached, for example, to a multimedia message. The list of corresponding words and expressions in the dedicated dictionary 5M is therefore, for example: ‘beach’; ‘sand’; ‘blue sky’; ‘sea’; ‘dog’; ‘outdoors’; ‘John’; ‘landscape’; ‘friend’; ‘girlfriend’; ‘wife’; ‘child’; ‘husband’; ‘son’; ‘daughter’; ‘John and a friend’; ‘John and his wife’; ‘John and his son’.

A more advanced embodiment of the invention consists taking each of the words and expressions in this list and deducing other related words or expressions, or order to propose a wider contextual vocabulary when inputting the text. The previously inputted words ‘friend’, ‘girlfriend’, ‘wife’, ‘husband’, ‘son’, ‘daughter’, ‘child’, or the combinations ‘John and a friend’, ‘John and his wife’, ‘John and his son’, are examples of this. In the same way, the system can go on to deduce, based on the words ‘beach’ and ‘blue sky’, the words ‘sunny’, ‘sun’, ‘hot’, ‘heat’, ‘holiday’, ‘swimming’, ‘tan’, etc. This new list of words is deduced empirically, i.e. without any real semantic analysis of the content of the image or video. Furthermore, for each given class (the number and nature of which are set by the image analysis algorithm) or ‘scene’ mode (the number and nature of which are set by the image capture device that generated the photo), it is possible to associate a discrete list of associated keywords that will be attached to the dictionary 5M. Since these word sub-lists are deduced empirically, it is likely that some of the words will not be relevant. For example, the photograph may have been taken while it was raining. Hence, detecting that the scene is a ‘beach’ scene is no guarantee that the words ‘sunny’ and ‘heat’, for example, can be reliably associated. The description that follows will show how the use of context associated with the image partially resolves this ambiguity.

Given the descriptions outlined above, these words and expressions present a hierarchy that can be integrated into the dictionary 5M. More specifically, it was described above that certain of these words and expressions were derived from others. This represents the first level in the hierarchy. In the above-mentioned example, the words ‘sunny’, ‘sun’, ‘hot’, ‘heat’, holidays’, ‘swimming’ and ‘tan were all derived from the word ‘beach’, whereas the word beach had itself been deduced from the detection of features known as low-level semantic information, such as ‘blue sky’ or ‘white sand’. These so-called ‘parent-child’ type dependencies can be exploited when displaying the dictionary words while the user is in the process of inputting text associated with the content of a multimedia message. More precisely, if two words are likely to be written, for example ‘blue sky’ and ‘beach’, that both begin with the same letter, i.e. ‘b’, then the expression ‘blue sky’ will either be displayed first, or can be highlighted, for example using a protocol based on colour, font, size or position. The word ‘beach’, which derived from the expression ‘blue sky’, will be proposed later, or less explicitly than the expression ‘blue sky’. Similarly, the method gives stronger ties, i.e. it establishes a hierarchy or an order system, between words and expressions derived from semantic analysis of the multimedia content on one hand, and on the other the ‘scene’ mode selected (by the user) to capture the image. The method preferentially chooses, or highlights, words and expressions that characterize the scene, for example ‘landscape’ or ‘sport’, when the scene has been selected manually at image capture, using, for example, a thumbwheel or a joystick built in to the mobile terminal. This word characterizing a mode intentionally selected by the user is presented in priority compared to other words obtained based on semantic analysis of the visual or audio content attached to the multimedia message. For example, the word ‘landscape’ deduced from the fact that the ‘landscape’ mode had been selected is chosen preferentially or highlighted over the word ‘beach’ obtained form the image analysis, since the results of the image analysis may later prove to have been incorrect.

It is also possible to establish a hierarchy between words and expressions that in principle have the same level, i.e. they have been extracted or deduced using the same techniques. For example, the words ‘beach’ and ‘John’ are both deduced via an analysis of image contents. It is possible, for example, that the image classification process can give a 75% probability that the image depicts a beach. Similarly, the face recognition process may, for example, determine that there is an 80% chance that the face is John's face and a 65% chance that the face is Patrick's face. The word ‘beach’ can therefore be chosen preferentially or highlighted over the word ‘Patrick’, even though both words stemmed from the semantic analysis of the image, since the word ‘beach’ is probably a more reliable deduction than the word ‘Patrick’. This word database 5M can then be used to fully implement the method for predicting word input that is the object of the invention.

A particular embodiment of the invention consists in implementing the method according to the invention using, for example, a mobile cellphone 1. The image 6 is selected using keypad 2 on the mobile phone, for example by searching for and finding image 6 in the image database (5I). The image 6 can be selected, for example, using an messaging interface such as an MMS messaging interface, or any other software application capable of associating text with an image or a sequence of images in order to share this association. The selection step of an image or sequence of images 6 launches the semantic and contextual image analysis process, as described above, in order to build the dedicated dictionary 5M. The dictionary created by the analysis of image 6 representing, for example, a beach setting, as described above, would for example in this case contain the words: ‘beach’; ‘sand’; ‘blue sky’; ‘sea’; ‘dog’; ‘outdoors’; ‘John’; ‘landscape’; ‘friend’; ‘girlfriend’; ‘wife’; ‘husband’; ‘son’; ‘daughter’; ‘John and a friend’; ‘John and his wife’; ‘John and his son’; ‘sunny’; ‘sun’; ‘hot’; ‘heat’; ‘holidays’; ‘swimming’; ‘tan’.

As depicted in FIG. 2, image 6 is displayed on display 3 of mobile phone 1. The user of mobile phone 1 then writes additional comments to add to image 6. The user therefore inputs text using keypad 2. The text-based comment to be written is, for example: “Hi, sunny weather at the beach”. The user starts writing the first part Tₒ of the text: “Hi, sunny w”. This text can be written either via a conventional input system (whether predictive or not), such as Multi-tap, two-key, T9® or iTap. Tₒ is written, for example, in the part of display 3 beneath image 6. At this point, i.e. at the moment the letter ‘w’ is entered, a single proposition made of one (or several) word(s) is, for example, displayed on the display. This proposition 9 is, for example, ‘sunny’. This word was derived from dictionary 5M and was deduced from the semantic image analysis carried out as per the method according to the invention. This word therefore has a fairly good chance of being used by the user as they write the text associated with image 6. This is why the message is not only displayed on the display as soon as the first letter has been entered but is also listed preferentially among any other propositions that may be offered after the keypress ‘s’ in the event that would be not one but, for example, three propositions 7, 8 and 9 (FIG. 2). For example, in the scenario where the method according to the invention is used in combination with the iTap protocol, it is possible that another word beginning with the letter ‘s’ is displayed at the same time as the word ‘sunny’ derived from the dictionary 5M. However, in this scenario, it is the word ‘sunny’ that would be displayed first in the list of propositions displayed. The appropriate word, ‘sunny’, is confirmed by the user, for example by pressing a key in keypad 2. The word 9 ‘sunny’ would then automatically be inserted into the text to create text T₁: “Hi, sunny weather”. If the word 9 does not suit the user, i.e. the user did not want the word ‘sunny’, then the user continues to input, for example, ‘su’ and then ‘sun’, et cetera, until the appropriate word is automatically written or proposed.

The user goes on to input the last part of the text: “Hi, sunny weather at the b”; at this point, i.e. as soon as the letter ‘b’ has been entered, a single word 10 is proposed on the display, i.e. ‘beach’. The word 10 ‘beach’ would then be automatically inserted into the text to create text T₂: “Hi, sunny weather at the beach”.

In a more advanced embodiment of the invention, text can be inputted orally. The text is not entered by pressing keys on keypad 2, but the user of mobile cellphone 1 would use, for example, their own voice to input the text data. In this embodiment of the invention, mobile phone 1 is equipped, for example, with a microphone that works with a voice recognition module. Using the previous text-based comment as an example, the user would simply pronounce the letter ‘s’ and, in the same way as described in the illustrations above, either a single proposition or else three propositions would be displayed. The dictionary 5M is advantageously kept to a limited, manageable size to avoid too many words being displayed.

The predicted and proposed word can also be produced based on a contextual analysis of the image or sequence of images selected using terminal 1. The contextual analysis can advantageously provide, for example, geolocation data specific to the image or sequence of images. This geolocation data is preferably the place where the image or sequence of images was captured. The contextual image analysis algorithm can also provide time-based data specific to the image or sequence of images, such as for example dating data on the precise moment the image or sequence of images was captured.

In a preferred, more advanced embodiment of the invention, the predicted proposed word is produced based on a semantic analysis and based on a contextual analysis of the image. This means that a semantic analysis of the selected image or sequence of images and then a contextual analysis are performed either jointly or successively, in no particular order.

As regards the contextual image analysis, one or several words characterizing relevant geolocation data for image 6 captured with the phonecam 1 can be extracted using a GPS module built into the phonecam. This latitude/longitude data can, for example, be associated with a street name, a district, a town or a state, such as ‘Los Angeles’. This data is added instantaneously to dictionary 5M. In an advantageous embodiment, other words or expressions can be automatically deduced automatically from the geolocation coordinates for ‘Los Angeles’ and included in the dedicated dictionary 5M. These other deduced words are, for example: ‘Laguna Beach’; ‘Mulholland Drive’; ‘California’; ‘United States’.

Again, as regards the contextual image analysis, one or several words characterizing relevant time-based data for image 6 captured with the phonecam (1) can be added instantaneously to the dictionary, such as words like ‘weekend’, ‘afternoon’, ‘summer’, according to whether the image was captured at the weekend, or an afternoon, or in the summer.

A contextual image analysis can also be performed based on other data compiled, such as for example in an address book that can be accessed using terminal 1. In this case, we are dealing not with the context of image capture but the local context of the image. In this example, the address book may contain predefined groups of contacts that share a certain relationship with the person in image 6. If ‘John’ features in the image and a group in the address book already contains the names ‘John’, ‘Christopher’ and ‘Marie’, then the word database 5M can be enhanced with all three of these names (and not only ‘John’).

Another advantageous embodiment of the invention also makes it possible to automatically propose words or expressions deduced from the contextual analysis, as described above for the semantic analysis. For example, using knowledge of the date, time and geolocation of the image gained at the moment the image was captured, it is possible to deduce a predefined set of words such as ‘hot’, ‘heat’, et cetera, based on the fact that the image was captured in full daylight, in summer, and at a latitude where traditionally the weather is hot in this season and at this time of the day. In the scenario where the mobile terminal is connected to a remote database, for example a meteorological database, it is possible to crosscheck the air temperature at the time the image was captured. This temperature information, for example ‘30° C.’, can be used to generate or validate the words ‘hot’ and ‘heat’ as well as be used in the dictionary 5M.

Words or expressions derived from the semantic analysis can be confirmed with a much higher probability, or else be overruled by crosschecking these words or expressions against data derived from the contextual analysis. For example, we previously saw how the words ‘hot’ and ‘sunny’ had been deduced from the word ‘beach’. The image capture date and geolocation data may, however, demonstrate that the image was taken in winter and at night-time, in which case the words derived from semantic analysis would be eliminated form the dictionary 5M.

FIG. 3 illustrates another embodiment of the method according to the invention. The user of mobile phone 1 wants to write additional comments to add to image 6. The user therefore inputs text using keypad 2. The text to be added as a comment is, for example, “Hi, sunny weather at the beach. John”. The protocol for writing this text is exactly the same as the embodiment of the invention illustrated in FIG. 2, up to text stage T₁: “Hi, sunny weather”. The user goes on to input the rest of the text: “Hi, sunny weather at the b”; at this point, i.e. as soon as the letter ‘b’ has been entered, two words 11 and 12 are proposed on the display 3, for example ‘beach’ and ‘Laguna Beach’. The user, who initially had not thought about specifying the actual name of the beach depicted in image 6, is thus given two propositions 11 and 12, including the expression 12

‘Laguna Beach’, which they end up selecting. This gives text T₃: “Hi, sunny weather at Laguna Beach”. The user then finishes entering their text: “Hi, sunny weather at the beach. J”; at this point, i.e. as soon as the letter ‘J’ has been entered, two words 13 and 14 are proposed on the display 3, for example ‘John’ and ‘Patrick’. The user, whose first name is John, wishes to sign their text message, and therefore validates word 14, ‘John’. The final, completed text T₄ associated with image 6 is therefore: “Hi, sunny weather at Laguna Beach. John”. ‘Patrick’ was also proposed since the semantic image analysis was able to recognize that Patrick featured in image 6.

Furthermore, the first name ‘Patrick’ was proposed when the letter required was a T because the invention method works on the supposition that the user wanted to add a first name. Indeed, since the dictionary 5M contained a first name beginning with the letter ‘J’, the word ‘John’ is identified as such, since it is derived from a face recognition phase based on the image or sequence of images. However, the method according to the invention also proposes in second place the other first name(s) obtained and available through this recognition phase, i.e. ‘Patrick’ in this example.

While the invention has been described with reference to its preferred embodiments, these embodiments are not limiting or restrictive of the claimed protection.

### PART LIST

1. terminal
2. keypad of the terminal
3. display screen of the terminal
4. wireless communication link
5. server
6. image or sequence of images
7. word(s)
8. word(s)
9. word(s)
10. word(s)
11. word(s)
12. word(s)
13. word(s)
14. word(s)
text T₀
text T₁
text T₂
text T₃
text T₄

1. A method, using a terminal connected to a keypad and a display, for automatically predicting at least one word saved in a word database that can be accessed using the terminal, this at least one word characterizing content, context, or both, associated with an image or a sequence of images, the at least one word having been predicted in order to complete a text-based message associated with the image content or the context of the image or sequence of images while inputting the message text using the terminal, said method comprising the following steps:
a) selecting the image or the sequence of images using the terminal;
b) automatically adapting the word database to compile words derived from a content analysis, a contextual analysis, or both, specific to the image or to the sequence of images;
c) based on at least one new letter entered into the text using the terminal, automatically predicting and proposing at least one word beginning with the at least one new letter, this word being a word saved in the database;
d) automatically inserting the at least one predicted and proposed word into the text.

2. The method according to claim 1, wherein the context associated with the image or sequence of images is a context in which the image or sequence of images was captured.

3. The method according to claim 1, wherein the context associated with the image or sequence of images is a local context associated with the image or sequence of images.

4. The method according to claim 1, wherein the selection of the image includes the display of the image or sequence of images on a display of terminal.

5. The method according to claim 4, wherein the inputted text is displayed on the display of the terminal.

6. The method according to claim 1, wherein the predicted and proposed word is displayed on the display of the terminal.

7. The method according to claim 6, wherein the word predicted and proposed during step b) can be selected by pressing on the display, whereby said word is pressed on the display when several propositions have been predicted.

8. The method according to claim 6, wherein the word predicted and proposed during step b) can be selected using the keypad of the terminal when several propositions have been predicted.

9. The method according to claim 1, wherein the automatic prediction and proposal of at least one word is conducted in cooperation with another predictive text input method such as the T9® protocol.

10. The method according to claim 1, wherein the word proposed is produced based on a semantic analysis of the selected image or sequence of images using a classification of the pixels or a statistical analysis of the pixel distributions or a spatiotemporal analysis of the pixel distributions over time or a recognition of the outlines produced by sets of connected pixels conducted on the selected image or sequence of images.

11. The method according to claim 10, wherein the word proposed is further produced based on the mode of image capture selected with the terminal.

12. The method according to claim 1, wherein the word proposed is produced based on a contextual analysis of the selected image or sequence of images that provides geolocation data, dating data, or both, specific to the image or sequence of images.

13. The method according to claim 12, wherein the word proposed is produced based on a contextual analysis that provides time-based data specific to the image or sequence of images.

14. The method according to claim 1, wherein the word proposed is produced based on semantic analysis of the image or sequence of images selected and based on a contextual analysis of the selected image or sequence of images.

15. The method according to claim 14, wherein the word proposed is deduced automatically from a word contained in the word database.

16. The method according to claim 14, wherein the word proposed is, in addition, produced based on a semantic analysis of audio data associated with the selected image or sequence of images.

17. The method according to claim 1, wherein the at least one predicted word is displayed, using the display means, in a viewing window that is positioned alongside the selected image or sequence of images.

18. The method according to claim 1, wherein the digital data of the selected image or sequence of images and of the associated text-based message are saved in a file such as an MMS (Multimedia Messaging Service) format file.
